(19) United States
(12) Patent Application Publication
(10) Pub. No.: US 2010/0322824 A1
(43) Pub. Date: Dec. 23, 2010

(54) BIOSENSOR CARTRIDGE

(75) Inventor: Jacobus Hermanus Maria Neijzen, Heeze (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/740,131

(22) PCT Filed: Oct. 30, 2008
(86) PCT No.: PCT/IB08/54513

§ 371 Date: Apr. 28, 2010

(30) Foreign Application Priority Data
Nov. 5, 2007 (EP) 07119962.4

(51) Int. Cl. G01N 30/00; G01N 21/00; G01N 21/64

(52) U.S. Cl. 422/69; 422/68.1; 422/82.05; 422/82.08

(57) ABSTRACT

The present invention provides a cartridge comprising a sample input portion and a sensor portion, wherein said sensor portion comprises a sensor surface and a first microstructure adapted to provide a capillary force for transporting sample fluid from the sample input portion to the sensor portion, wherein said microstructure does not interfere with the sensor surface.

### FIELD OF THE INVENTION

The invention relates to a cartridge for use in a bio sensor with optical read-out.

### BACKGROUND OF THE INVENTION

The demand for biosensors is increasingly growing these days. Usually, biosensors allow for the detection of a given specific molecule within an analyte, wherein the amount of said molecule is typically small. For example, one may measure the amount of drugs or cardiac markers within saliva or blood. Therefore, target particles, for example fluorescent and/or super-paramagnetic label beads, are used which bind to a specific binding site or spot only, if the molecule to be detected is present within the analyte. There are several known optical techniques to detect these label particles bound to the binding spot. For instance, fluorescence microscopy or techniques using total internal reflection may be used for this purpose.

Since these techniques already are or are expected to become a standard tool in biosensing, there is a growing need for cartridges which may be used in combination with optical read-out techniques. Since biosensors based on immuno-reactions need to be disposable, because the biochemical material inside the cartridge is altered during an experiment, there is, in particular, a need for cheap disposable biosensor cartridges.

In several applications, the liquid sample to be analyzed by an optical read-out technique has to be filtered prior to the measurement. For example, for an immuno-assay of blood a filtering step to extract the plasma from the blood is needed to guarantee optimal functioning. Due to the often limited amount of sample and in order to provide a cheap solution, it is advantageous if the filter can be included into the disposable cartridge. However, usually a force is necessary to press a sample through a filter membrane. At the same time, the use of syringes or the like to push a sample through the membrane is restricted due to the amount of sample material, which often is extremely small.

### SUMMARY OF THE INVENTION

It is therefore an object of the present invention to provide an improved cartridge for biosensors. This object is achieved with the features of the claims.

The present invention is based on the idea to provide a biosensor-cartridge which utilizes capillary forces to transport a liquid sample from a sample input portion to the sensor surface of the biosensor-cartridge.

Accordingly, the present invention provides a biosensor-cartridge comprising a sample input portion and a sensor portion, wherein said sensor portion comprises a sensor surface and a first microstructure adapted to provide a capillary force for transporting sample fluid from the sample input portion to the sensor portion, wherein said microstructure does not interfere with the sensor surface.

Preferably, the sensor surface is adapted for use as an optical detection surface in an optical read-out technique. Suitable read-out techniques are in particular techniques which allow for probing a thin layer above the sensor surface, e.g., fluorescence microscopy, confocal microscopy, total internal reflection (TIR) and frustrated total internal reflection (FTIR) microscopy.

In particular, the first microstructure does not interfere with said optical read-out. This means, e.g., that the first microstructure and the sensor surface used for detection or optical read-out are arranged such that light used for said detection is not or only to a small extent scattered at said microstructure. It may further be necessary to provide a certain distance between the first microstructure and the sensor surface. Preferably, said distance is at least 1 μm. But this may depend on the application. For instance, in case of FTIR space for the label particles is needed above the sensor surface during the washing step. Thus, for an FTIR application the distance between sensor surface and microstructure will typically be about 10 μm.

The first microstructure provides and/or increases a capillary force in order to transport sample without reducing the sample volume adjacent the sensor surface too much. Furthermore, it is apparent to the skilled person that the size range of the microstructure has to be adapted with respect to the specific application. Several different ways of providing such a microstructure are conceivable. For instance, the microstructure may comprise pillars, pyramids, trenches, indentations or the like. Also combinations of different structure elements may be used.

According to a preferred embodiment of the present invention, the biosensor-cartridge further comprises a filter and optionally a second microstructure in contact with the filter. Said second microstructure is adapted to transport liquid sample through the filter and may comprise the same elements already mentioned with respect to the first microstructure.

The bio sensor-cartridge may also comprise a fluidic channel connecting the sample input portion with the sensor portion. Said fluidic channel may optionally comprise a third microstructure.

In order to provide a bio sensor-cartridge suitable for biosensing, the sensor surface preferably contains a reagent or a combination of several reagents. It is advantageous if the reagent or the combination of several reagents is situated at specific binding spots of the sensor surface. Therein, different binding spots may comprise different reagents. Alternatively or additionally, a reagent or a combination of several reagents may be provided within or on the first microstructure.

Furthermore, label particles suitable for the optical read-out technique may be provided within the biosensor-cartridge. These label particles may comprise specific capture molecules, for example they may be coated with these molecules. The label particles may also be fluorescent and/or contain magnetic particles. They could, e.g., be super-paramagnetic.

According to a preferred embodiment, the biosensor-cartridge may be an FTIR cartridge comprising a bottom portion, a middle portion and a top portion. The top portion comprises a filter and a first microstructure. The bottom portion has a second microstructure and a sensor surface; the middle portion comprises a fluidic channel. Therein, said bottom portion is adapted for allowing light to enter along a first optical path, to be reflected at the sensor surface and to exit along a second optical path, wherein the angle between first optical path and sensor surface fulfils the condition of total internal reflection.

Accordingly, light entering the bottom portion along the first optical path is completely reflected at said sensor surface. However, if the index of refraction close to said sensor surface is inhomogeneous, e.g., due to the presence of particles or the like, the condition of total internal reflection is—at least partially—violated. This leads to scattering of light at this inhomogeneity and thus to a decrease in intensity of the reflected light, which exits the bottom portion along the second optical path. Therefore, measuring the intensity of the reflected light allows for detection of particles present at or very close to the sensor surface.

The microstructure of the bottom portion is adapted to provide a capillary force suitable to force a liquid sample through the filter. Thus, advantageously, filter and second microstructure are in close contact with each other. Furthermore, it is apparent to the skilled person that the size range of the microstructure has to be adapted with respect to the filter chosen.

The top and/or bottom portion(s) of said biosensor-cartridge may be made of plastic, e.g., PET, polystyrene, polycarbonate, COP. Preferably one ore both of the portions may be moulded, e.g., injection moulded. Preferably, the microstructure is manufactured together with the bottom portion. For example, the microstructure may be injection-moulded or laser-milled as well. But it is also possible to manufacture the microstructure in a separate process and to attach it to the bottom portion, e.g. with an adhesive.

According to a preferred embodiment, the bottom portion of the biosensor-cartridge comprises a recess for accommodating a means for providing a magnetic field, e.g., a coil. Furthermore, the bottom portion may comprise an optical input surface and an optical output surface within first and second optical paths, respectively. Preferably, these surfaces are perpendicular to the first and second optical paths.

Preferably, the top portion further comprises a recess for supplying a sample onto the filter. Said filter may be adapted to filter, e.g., blood, essentially allowing only blood plasma to pass through.

These and other aspects of the invention will be apparent from and elucidated with reference to the embodiment(s) described hereinafter.

### BRIEF DESCRIPTION OF THE DRAWINGS

FIG. 1 schematically shows the functional principle of FTIR.

FIG. 2a schematically shows a cross section of a biosensor-cartridge according to the present invention.

FIG. 2b schematically shows a cross section of the biosensor-cartridge of FIG. 2a along line A-A.

FIGS. 3a to 3c schematically show a top portion, a middle portion and a bottom portion of a biosensor-cartridge according to the present invention, respectively.

### DETAILED DESCRIPTION OF EMBODIMENTS

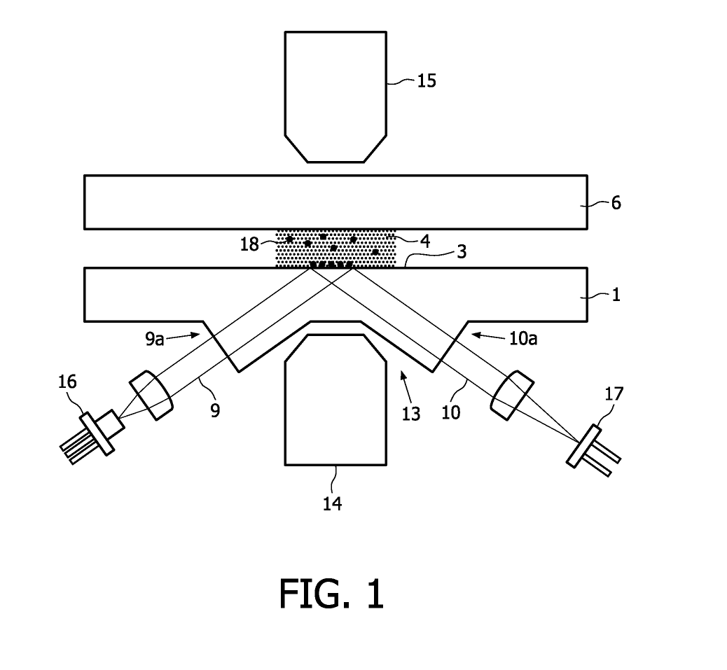

FIG. 1 schematically shows the functional principle of FTIR. Once the biosensor-cartridge is filled or supplied with a liquid sample, label particles 18, which have been supplied in dry form, redisperse into solution. Using a magnet 14, super-paramagnetic label particles 18 may be accelerated towards the sensor surface 3, where they may bind to the surface if the specific molecule to be detected is present in the sample. After some time sufficient for binding, magnet 15 may be used in order to remove label particles 18 which are not bound to the sensor surface 3, from said surface. After this ‘washing’ step or any other alternative washing step, the sensor surface 3 is illuminated with a laser or an LED 16. The light is reflected at sensor surface 3 and detected by detector 17, which may be a photo diode or a CCD camera. The optical path 9 of incoming light is chosen such that the condition of total internal reflection is fulfilled. In that case, an evanescent optical field is generated, which penetrates typically only 50-100 nm into the sample. Thus, only if the label particles 18 are sufficiently close to the sensor surface 3, the evanescent field is disturbed leading to a decrease of the intensity of the reflected light.

It is to be understood that FTIR is only an exemplary optical read-out technique. Other techniques which allow for probing a thin layer above the sensor surface, e.g., fluorescence microscopy, confocal microscopy or total internal reflection microscopy are conceivable as well. The skilled person will understand that the biosensor-cartridge has to be modified accordingly. However, this does not effect the general principle of the present invention.

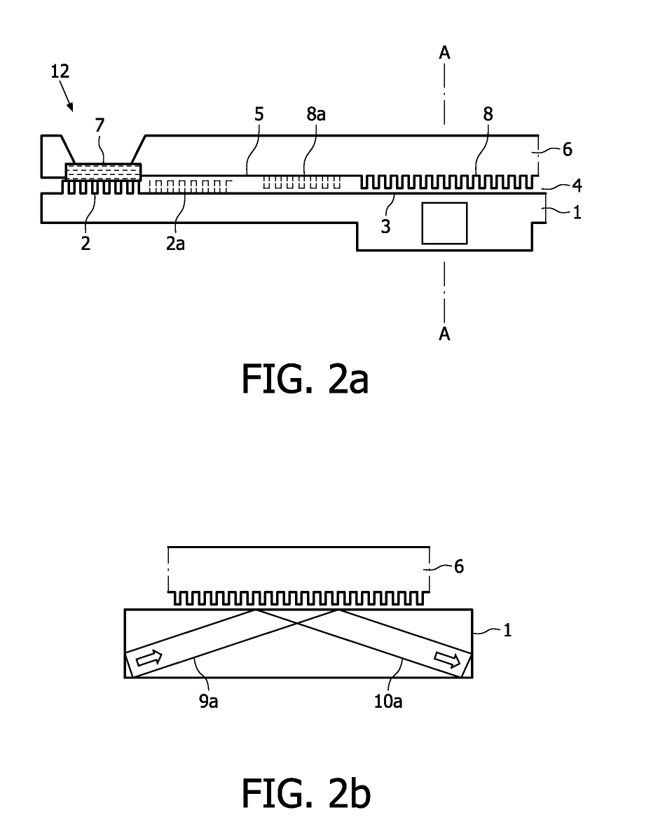

FIG. 2a schematically shows a cross section of a preferred embodiment of biosensor-cartridge according to the present invention. The biosensor-cartridge comprises a bottom portion 1, a middle portion 4 and top portion 6. The top portion 6 comprises a filter 7, which may be filled by adding a droplet of liquid sample into a recess 12. Said droplet is dragged through the filter 7 by capillary forces caused by a microstructure 2 arranged at the bottom portion 1 and projecting into the fluidic channel 5. The sample then flows through the fluidic channel 5 towards the sensor surface 3. This is supported by capillary forces caused by a microstructure 8 arranged at the top portion 6.

Although FIG. 2a shows pillar-like microstructures 2 and 8, other structure elements such as pyramids, trenches, indentations, grooves or the like may be used alternatively or in any combination. Apart from the exact shape of these elements, the characteristic feature determining the capillary forces is the width of the spaces or gaps between the pillars. The skilled person will understand that the dimensioning of the microstructure 2, fluidic channel 5 and the microstructure 8 has to be chosen such that fluid flow from the filter 7 all the way towards the sensor surface 3 is sufficiently supported. For this purpose, additional microstructures 2a, 8a may be provided along the fluidic channel 5, e.g., protruding from the top portion 6 and/or the bottom portion 1 as indicated in FIG. 2a. Typical intermediate distances between the elements of the microstructures are of the order of 10 to 100 μm.

FIG. 2b schematically shows a cross section of the biosensor-cartridge of FIG. 2a along line A-A together with the optical entrance and exit windows 9a and 10a.

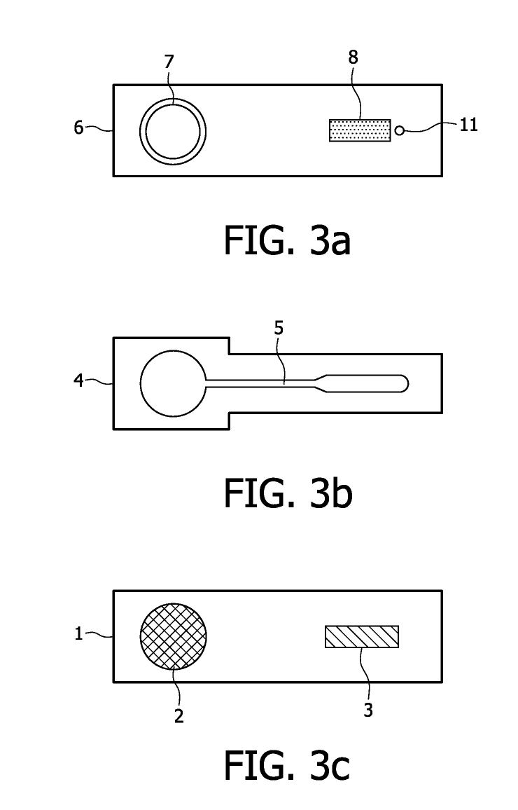

FIG. 3 schematically shows a top view of the top portion 6, the middle portion 4 and the bottom portion 1, respectively, of a biosensor-cartridge according to the present invention.

The bottom portion 1 comprises the microstructure 2 and the sensor surface 3. Said sensor surface 3 preferably contains a reagent or a combination of several reagents and label particles. The label particles may be coated with specific capture molecules and may further comprise magnetic particles. In a preferred embodiment, the reagents are situated at specific binding spots of the sensor surface 3. The reagents of different binding spots may also differ from each other in order to provide specific binding spots for different molecules to be analyzed. These molecules may be, e.g., anti-bodies or drug molecules.

The middle portion 4 may be, e.g., a double-sided tape with a cut-out portion. But it is also conceivable to use a molded piece of plastic or the like. The cut-out provides a fluidic channel 5 as well as space above the microstructure 2 and the sensor surface 3, which are available for the filter 7 and the liquid sample. Preferably, the shape of the cut-out corresponds to the shape of the microstructure 2, the filter element 7 and the sensor surface 3. Although, the exemplifying embodiment shows a circle and a rectangle, respectively, other shapes are possible as well. The thickness of the middle portion 4 defines the height of the fluidic channel 5 and is preferably between 0.1 and 0.2 mm. The channel width may be between 0.2 mm and 2 mm.

The top portion 6 comprises the filter 7 and the microstructure 8. Preferably, the shapes of the filter 7 and the microstructure 8 also correspond to the shape of the microstructure 2 and the sensor surface 3, respectively. Additionally, an air vent 11 is provided to allow air to escape from the sample volume, when the sample is filled into the biosensor-cartridge. The filter 7 comprises a filter membrane adapted for a specific filtering process. For instance, the membrane may be adapted to filter blood, allowing only the blood plasma to pass through the filter pores. Filters that may be used are the BTS-SP asymmetric membrane filters of Pall Corporation. These filters have a gradient in pore size over the membrane thickness, allowing the capturing of cells, while transmitting the plasma.

If the middle portion 4 is a double-sided tape, top and bottom portions may be simply attached to each other via said tape. However, it is also possible to use an additional layer of adhesive or to weld or clamp the portions together.

In order to provide enough space for the ‘washing’ step of the FTIR described above, the distance between the microstructure 8 and the sensor surface 3 should be well above the diameter of the label particles, which typically is in the range between 0.1 and 1 μm. Thus, said distance should be at least 1 μm, preferably larger than about 10 μm.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. Biosensor-cartridge comprising a sample input portion (12) and a sensor portion, wherein said sensor portion comprises a sensor surface (3) and a first microstructure (8) adapted to provide a capillary force for transporting sample fluid from the sample input portion (12) to the sensor portion, wherein said microstructure (8) does not interfere with the sensor surface (3).

2. Biosensor-cartridge according to claim 1, wherein the sensor surface (3) is adapted for use as an optical detection surface in an optical read-out technique.

3. Biosensor-cartridge according to claim 1, wherein the distance between first microstructure (8) and sensor surface (3) is at least 1 μm.

4. Biosensor-cartridge according to claim 1, wherein the first microstructure (8) comprises one or a combination of the following elements: pillars, pyramids, trenches, indentations.

5. Biosensor-cartridge according to claim 1, further comprising a filter (7).

6. Biosensor-cartridge according to claim 5, further comprising a second microstructure (2) in contact with filter (7).

7. Biosensor-cartridge according to claim 1, further comprising a fluidic channel (5) connecting the sample input portion (12) with sensor portion.

8. Biosensor-cartridge according to claim 7, wherein the fluidic channel (5) comprises a third microstructure (2a, 8a).

9. Biosensor-cartridge according to claim 1, wherein the sensor surface (3) contains a reagent or a combination of several reagents.

10. Biosensor-cartridge according to claim 9, wherein the reagent or the combination of several reagents is situated at specific binding spots of the sensor surface (3).

11. Biosensor-cartridge according to claim 1, wherein the first microstructure (8) contains a reagent or a combination of several reagents.

12. Biosensor-cartridge according to claim 2, wherein the first microstructure (8) contains label particles suitable for the optical read-out technique.

13. Biosensor-cartridge according to claim 12, wherein the label particles comprise capture molecules and/or magnetic particles.

14. Biosensor-cartridge according to claim 2, wherein the optical read-out technique is one or a combination of the following: fluorescence microscopy, confocal microscopy, total internal reflection microscopy, frustrated total internal reflection microscopy.
